(19) United States
(12) Patent Application Publication
(10) Pub. No.: US 2017/0261086 A1
(43) Pub. Date: Sep. 14, 2017

(54) BEARING ASSEMBLY

(71) Applicant: GM GLOBAL TECHNOLOGY OPERATIONS LLC, Detroit, MI (US)

(72) Inventors: Norman Parker, Clarkston, MI (US); Jevon Kennell, Howell, MI (US)

(21) Appl. No.: 15/069,031

(22) Filed: Mar. 14, 2016

(51) Int. Cl. F16H 48/40; F16H 48/08; F16C 19/36

(52) U.S. Cl. CPC F16H 48/40; F16C 19/361; F16H 48/08; F16C 2229/00; F16C 2361/61; F16H 2048/405

(57) ABSTRACT

A bearing assembly comprises a cone member configured to receive rollers therein. A bearing cup is configured for receipt of the cone member therein and for rolling contact with the rollers thereon. A bearing cup pocket extends circumferentially about the rear face of the bearing cup and that is configured to receive a biasing member therein.

### FIELD OF THE INVENTION

The subject of the invention is related to drive systems for motor vehicles and, more particularly, to a preloaded roller bearing assembly.

### BACKGROUND

Vehicle drive systems typically utilize one or more rotatable shafts supported by lubricated bearing assemblies that are mounted within various housing openings, for instance, through which the rotatable shafts extend. Pre-loading of the bearing assemblies may, at times, be required. Such pre-loading can be particularly important in housings constructed of materials that experience dimensional variation due to thermal expansion/contraction during operation (ex. Aluminum).

Preloading may require the addition of a biasing member to the bearing assembly which can add to its overall axial dimension. An increase in a bearing assembly's axial length may not be desirable or possible; especially when such a pre-load feature is a necessary addition to a pre-existing design. A bearing assembly having a biasing member for applying axial pre-loading is necessary where changes to existing bearing mounting architecture is not desirable.

### SUMMARY

In an exemplary embodiment a bearing assembly comprises a cone member configured to receive rollers in rolling engagement therewith. A bearing cup is configured to receive the cone member therein and to engage in rolling contact with the rollers. A bearing cup pocket extends circumferentially about a face of the bearing cup and is configured to receive a biasing member therein.

In another exemplary embodiment, a bearing assembly, for supporting a rotatable shaft in a housing, comprises a cone assembly with a cone member having a roller track configured to receive rollers therein. A cage member is configured to retain the rollers in the roller track. A bearing cup comprises an inner roller surface configured to receive the cone assembly and to establish rolling contact with the rollers, and an outer circumferential surface having a diameter “D” that facilities insertion of the bearing assembly into a bearing opening of the housing. A face of the bearing cup comprises an outboard face of the bearing assembly that is engageable with a retaining member to maintain the assembly in the bearing opening of the housing, and a bearing cup pocket extends circumferentially about the outboard face of the bearing cup and is configured to receive a biasing member that operates to exert a biasing force “F” between the retaining member and the bearing cup.

In yet another exemplary embodiment a vehicle having a differential assembly comprises a differential housing having a differential gear set, arranged within an interior portion and, supported for rotation within the differential housing by a bearing assembly that is seated within a bearing opening in the housing. The bearing assembly comprises a cone assembly comprising a cone member having a front face, a rear face, a base and a roller track configured to receive rollers therein. A cage member retains the rollers in the roller track. A bearing cup has a front face, a rear face, an inner roller surface for receipt of the cone assembly therein and for rolling contact with the rollers thereon, and an outer circumferential surface having a diameter “D” that facilities insertion of the bearing assembly into the bearing opening of the differential housing. The rear face of the bearing cup comprises an outboard face of the bearing assembly that is engageable with a retaining member to maintain the assembly in the bearing opening of the housing. A bearing cup pocket extends circumferentially about the rear face of the bearing cup to define an inset shoulder that is configured to receive a biasing member operable to exert a biasing force “F” between the retaining member and the bearing cup; wherein the biasing force “F” urges the bearing cup into a seated position in the bearing opening resulting in alignment of the bearing assembly.

The above features, advantages and details appear, by way of example only, in the following detailed description of embodiments, the detailed description referring to the drawings in which:

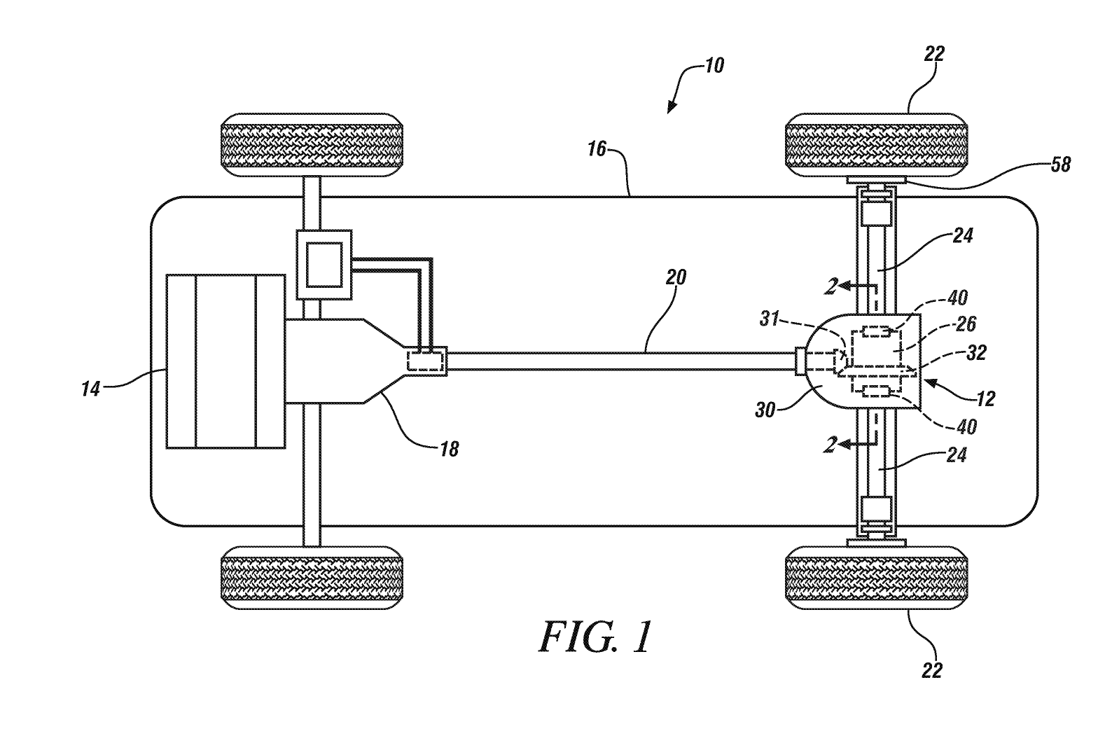

FIG. 1 is a schematic plan view of a vehicle and drivetrain embodying features of the invention;

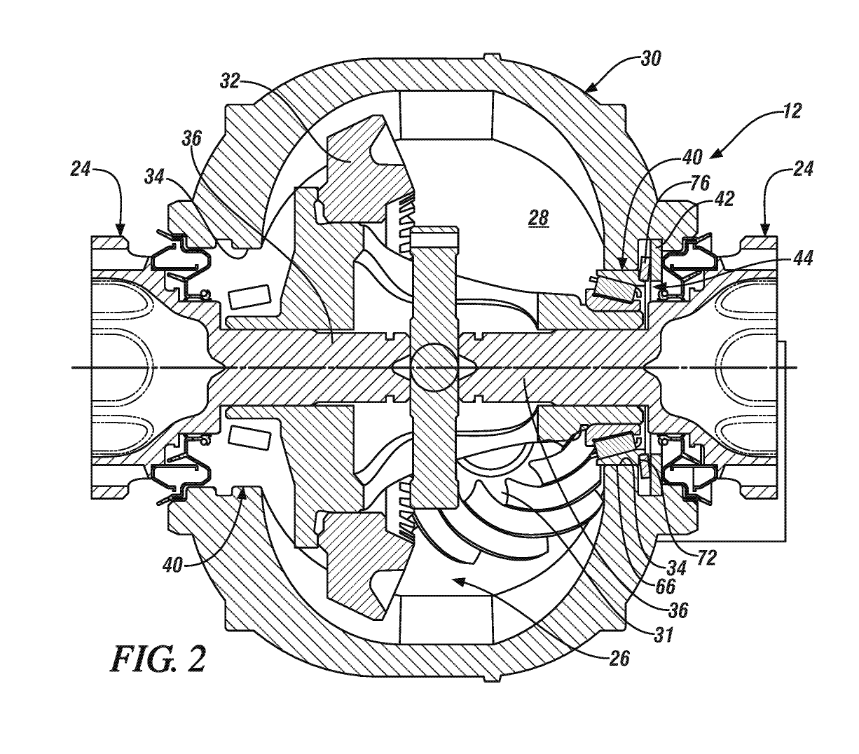

FIG. 2 is a rear sectional view, taken along Line 2-2 of FIG. 1, of a differential assembly embodying features of the invention;

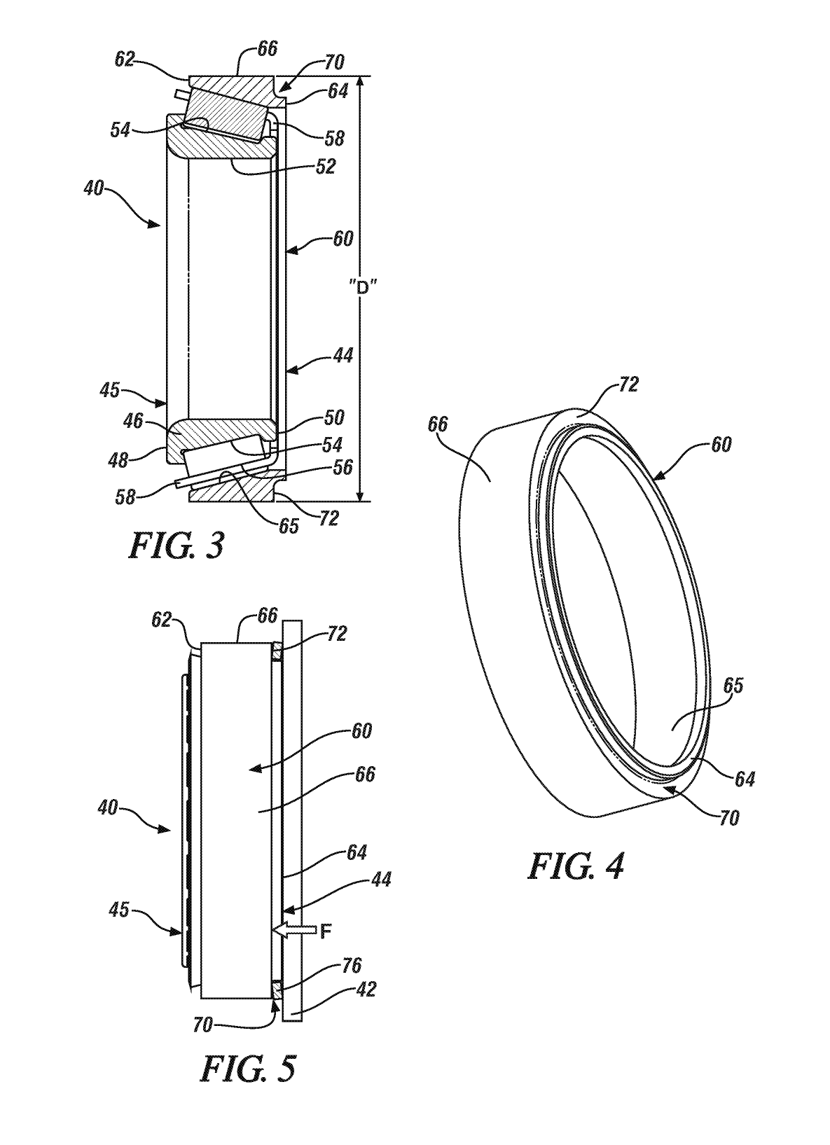

FIG. 3 is a sectional view of a bearing assembly embodying features of the invention;

FIG. 4 is a perspective view of a portion of the bearing assembly of FIG. 3; and

FIG. 5 is a side view of the bearing assembly of FIG. 3.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts or features. As used herein, the term vehicle is not limited to an automobile, van, truck or sport utility vehicle, but may include any self-propelled or towed conveyance suitable for transporting a burden. The embodiments described and illustrated herein are applicable to vehicle components, but the assembly disclosed may be used in any suitable applications in which rotating components are subject to support in corresponding bearing assemblies (ex. transportation, energy, machinery and aerospace applications, for example).

In accordance with an embodiment of the invention, FIG. 1 illustrates a vehicle 10, having a differential assembly 12. The vehicle 10 may include an engine 14, such as a gasoline or diesel fueled internal combustion engine, for example. The engine 14 may further be a hybrid-type engine that combines an internal combustion engine with an electric motor. The engine 14 and the differential assembly 12 are mounted to a frame or other chassis structure 16. The engine 14 is coupled to the differential assembly 12 through a transmission 18 and a driveshaft 20. The transmission is configured to reduce the rotational velocity and to increase the torque output of the engine 14. The differential assembly 12 transmits the torque output from the driveshaft 20 to driven wheels 22 via axle assemblies 24 through a differential gear set 26.

Referring now to FIG. 2, with continuing reference to FIG. 1, the differential gear set 26 is arranged within an interior portion 28 of a differential housing 30 of the differential assembly 12. The differential gear set 26 receives the output from the driveshaft 20 via a pinion 31 that transmits the torque to a ring gear 32. The differential gear set 26 is supported for rotation within the differential housing 30 by a pair of bearing assemblies 40 that are seated within bearing openings 34 on opposite sides of the differential gear set. The differential gear set 26 is coupled to, and supports inner ends 36 of the axle assemblies 24. A retaining member 42 such as snap ring is located against the outboard face 44 of each bearing assembly 40 and maintains the assembly in position within the bearing openings 34 of the differential housing 30.

Referring to FIGS. 2 through 5, the bearing assembly 40 includes a cone assembly 45 comprising a cone member 46 having a front face 48 a rear face 50 and a base 52. The cone member includes a roller track 54 that is configured to receive rollers 56 therein. The rollers 56 may comprise ball bearings, roller bearings, needle bearings or any other suitable bearing. A cage member 58 may retain the rollers 56 in the roller track 54. The cone assembly 45 is insertable into a bearing cup 60. The bearing cup includes a front face 62, a rear face 64 and an inner roller surface 65 with which rollers 56 make rolling contact. An outer circumferential surface 66 has a diameter “D” that facilities insertion of the bearing assembly 40 into bearing opening 34 of the differential housing 30. The rear face 64 of the bearing cup 60 comprises the outboard face 44 of the bearing assembly 40 against which the retaining member 42 is engaged to maintain the assembly in position within the opening 34 of differential housing 30.

A bearing cup pocket 70 extends circumferentially about the rear face 64 of the bearing cup 60 to define an inset shoulder 72 that is configured to receive a biasing member 76 therein. In an exemplary embodiment, the biasing member 76 is a Bellville washer that operates to exert a biasing force “F” between the retaining member 42 and the bearing cup 60. During operation of the differential assembly 12, temperature excursions may cause the temperature of the differential housing 30 to vary; resulting in thermal expansion and contraction thereof. The result of the thermal expansion of the differential housing 30 may be a loosening of the bearing assembly 40 in the bearing opening 34. The biasing force “F” maintains the bearing cup 60 in a seated position in the bearing opening 34 regardless of dimensional variation of the differential housing 30. The application of the bearing cup pocket 70 of the invention provides for the addition of the biasing member 76 in the bearing assembly 40 without varying the axial length required in the differential housing for application of axial pre-loading to the bearing assembly 40.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation material to the teachings of the invention without departing from the essential scope thereof. Therefore, it is intended that the invention not be limited to the particular embodiments disclosed, but that the invention will include all embodiments falling within the scope of the application.

What is claimed is:

1. A bearing assembly comprising:
a cone member configured to receive rollers in rolling engagement therewith;
a bearing cup configured to receive the cone member therein and for rolling contact with the rollers, and;
a bearing cup pocket extending circumferentially about a face of the bearing cup and configured to receive a biasing member therein.

2. The bearing assembly of claim 1, wherein the face of the bearing cup comprises an outboard face of the bearing assembly against which a retaining member is placed to maintain the bearing assembly in a desired position.

3. The bearing assembly of claim 2, wherein the biasing member operates to exert a biasing force “F” between the retaining member and an inset shoulder of the bearing cup pocket.

4. The bearing assembly of claim 1, wherein the biasing member comprises a Bellville washer.

5. A bearing assembly, for supporting a rotatable shaft in a housing, comprising:
a cone assembly comprising a cone member having a roller track configured to receive rollers therein;
a cage member configured to retain the rollers in the roller track;
a bearing cup comprising:
an inner roller surface configured to for receive the cone assembly therein and to establish rolling contact with the rollers, and
an outer circumferential surface having a diameter “D” that facilities insertion of the bearing assembly into a bearing opening of the housing, wherein a face of the bearing cup comprises an outboard face of the bearing assembly engageable with a retaining member to maintain the assembly in the bearing opening of the housing; and
a bearing cup pocket extending circumferentially about the outboard face of the bearing cup and configured to receive a biasing member that operates to exert a biasing force “F” between the retaining member and the bearing cup.

6. The bearing assembly of claim 5, wherein the biasing member comprises a Bellville washer.

7. A vehicle having a differential assembly comprising:
a differential housing having a differential gear set arranged within an interior portion thereof and supported for rotation within the differential housing by a bearing assembly that is seated within a bearing opening in the housing, the bearing assembly comprising:
a cone assembly comprising a cone member having a front face, a rear face, a base and a roller track configured to receive rollers therein;
a cage member retaining the rollers in the roller track;
a bearing cup having a front face, a rear face, an inner roller surface for receipt of the cone assembly therein, and for rolling contact with the rollers thereon, and an outer circumferential surface having a diameter “D” that facilities insertion of the bearing assembly into the bearing opening of the differential housing, wherein the rear face of the bearing cup comprises an outboard face of the bearing assembly engageable with a retaining member to maintain the assembly in the bearing opening of the housing; and
a bearing cup pocket extending circumferentially about the rear face of the bearing cup to define an inset shoulder that is configured to receive a biasing member that operates to exert a biasing force “F” between the retaining member and the bearing cup, wherein the biasing force “F” urges the bearing cup into a seated position in the bearing opening resulting in alignment of the bearing assembly.

8. The vehicle of claim 1, wherein the biasing member comprises a Bellville washer.
